(19) United States
(12) Patent Application Publication
(10) Pub. No.: US 2008/0028864 A1
(43) Pub. Date: Feb. 7, 2008

(54) Device for controlling working stresses of elongated members, in particular safety belts and control method

(76) Inventor: Francis Gibert, Les Mesnuls (FR)

Correspondence Address: YOUNG & THOMPSON, 745 SOUTH 23RD STREET, 2ND FLOOR, ARLINGTON, VA, 22202, US

(21) Appl. No.: 11/579,492

(22) PCT Filed: May 2, 2005
(86) PCT No.: PCT/FR05/01094

§ 371 Date: Nov. 3, 2006

(30) Foreign Application Priority Data
May 4, 2004 (FR) 0404766

(51) Int. Cl. G01N 3/30

(52) U.S. Cl. 73/826; 73/12.01

(57) ABSTRACT

The invention concerns a device for controlling forces. It concerns a controlling device comprising a body defining a non rectilinear path for passing a strap (18) between two support members (14) arranged on one first side and a support member (16) arranged on the second side, and provided with a sensor of forces experienced during an impact test, each support member (14) being separable from the body. An additional support member geometrically interchangeable with a separable support member (14) is provided with a second force sensor having a measuring range covering the prior working stress of the strap, the controlling device having two different configurations depending on whether a separable member comprises the second force sensor or not. The invention is useful for testing safety belts during impact tests.

The invention relates to a tensile force control device for elongate elements, such as safety belt straps, and a method for controlling tensile forces of elements of this type.

Force control devices for safety belts are already known. They are generally used during crash tests which are intended to determine the properties of safety belts.

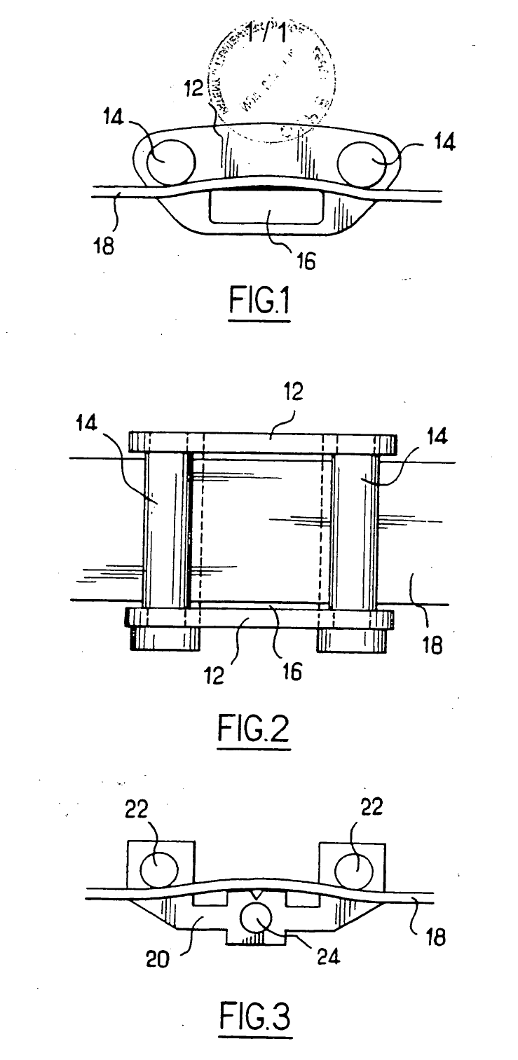

FIGS. 1 and 2 illustrate an example of a strap force control device of this type. As indicated in FIG. 1, a control device body comprises two end-plates 12 which support two supporting members or parallel bars 14 which are illustrated with a cylindrical cross-section, and an opposing supporting member 16. The supporting members together delimit a path through which a safety belt 18 passes. The path between the two bars 14 placed at one side and the member 16 placed at the other side is slightly sinuous so that, when a traction force is applied to the strap, a transverse component is applied at one side to the bars 14 and at the other side to the supporting member 16.

In the embodiment illustrated in FIGS. 1 and 2, the control device comprises a force sensor which is incorporated in the supporting member 16. This sensor is connected to a measurement device by means of a cable or a wireless connection. The measurement range of this sensor covers the values of the forces which are experienced during a crash test. In the various types of crash test, the forces applied must be able to reach at least 10 kN or 20 kN and even higher.

When a sensor of this type is used, the bars 14, which may be separated from the end-plates 12 by means of unscrewing, are removed, the body is placed on the strap and the bars are placed in position again. The friction which exists between the two bars and the supporting member prevents the force control device from moving along the strap 18, even when it is not horizontal.

A force sensor of this type is found to be satisfactory in strength verification tests for safety belt straps according to conventional standards.

It has now been found that it would be desirable to be able to carry out the crash tests after the strap has been brought to a preliminary tension. For example, in order to fix specific accessories, such as child seats, it is desirable for the strap to be subjected to a preliminary tensile force of 50 N. In a test of this type, it is therefore necessary, during a first step, to adjust the preliminary tension of the strap to a predetermined value, with this value being measured, then, in the subsequent crash test, to measure the forces applied to the strap.

It has been found that the force sensors used in the force control devices described with reference to FIGS. 1 and 2 did not have an adequate level of precision in the range of low values, and did not therefore allow the above-mentioned tests to be carried out without using an additional device.

It was therefore envisaged to replace the force sensor used with a sensor which has a higher level of precision in a range which covers the low force values. It was then found that a force control device equipped with a sensor of this type was very heavy. For example, whilst the force control device illustrated in FIGS. 1 and 2 has a weight of 65 g, a control device comprising a force sensor which is sufficiently precise to measure the preliminary tensile forces must have a weight in the order of 300 g.

In a crash test, the acceleration forces applied to the force control device are significant. A force control device having a low weight, such as that illustrated in FIGS. 1 and 2, does not interfere excessively with the measurements during a crash test, whilst a force sensor of 300 g interferes considerably since it is subjected to significant forces.

It would also be possible to envisage supplementing the force control device with a preliminary tensile force sensor having an adequate level of precision, for example, in one of the bars 14. In an embodiment of this type, however, the preliminary tensile force sensor would be destroyed during each crash test.

Taking into account the problem addressed, the invention relates to a tensile force control device for elongate elements, such as safety belt straps, which constitutes a simple, precise and inexpensive solution. This solution involves the use of an additional supporting member which is provided with a preliminary tensile force sensor and which can be interchanged with another of the supporting members of the force control device, this member being separable.

In this manner, in a first step, the force control device is provided with the member which comprises the preliminary tensile force sensor which is used to determine the preliminary tensile force. Then the separable member which is provided with the preliminary tensile force sensor is removed and replaced with a member which is geometrically interchangeable. In this manner, the preliminary tensile force is not modified and the force control device can absorb the forces which are experienced during the crash tests.

More precisely, the invention relates to a tensile force control device for elongate elements, of the type which comprises a body which delimits a non-rectilinear path for an elongate element to pass between at least two supporting members which are placed at a first side and at least one supporting member which is placed at the second side, at least one of the supporting members being provided with a force sensor which has a measurement range which covers the forces experienced during a crash test, each supporting member at least at one side of the path being able to be separated from the body, so that the tensile force control device can be placed on an elongate element by separating each separable supporting member from the body, then by fixing each separable supporting member to the body; according to the invention, the control device further comprises an additional supporting member which is geometrically interchangeable with a separable supporting member, the additional supporting member being provided with a second force sensor which has a measurement range which covers the preliminary tensile forces of the elongate element, the force control device having two different configurations depending on whether a supporting member which is separable from the body comprises the second force sensor or not.

In an advantageous embodiment, the body comprises two supporting members which are formed by two bars which are placed at a first side and a single supporting member which is placed at the second side. Preferably, the two supporting members are separable, and the additional supporting member is intended to replace one of the two separable supporting members. Preferably, the single supporting member at the second side comprises the first force sensor.

In a variant, one of the two separable members comprises the first force sensor.

In another embodiment, the additional supporting member is similar to the single supporting member at the second side and can be interchanged therewith. It is then advantageous for the single supporting member at the second side to comprise the first force sensor. In a variant, one of the two supporting members placed at the first side comprises the first force sensor.

Preferably, the body comprises two lateral end-plates which are intended to support the ends of the bars of the supporting members.

Preferably, the additional supporting member comprises at least one dynamometric gauge.

Preferably, the control device comprises a flexible cable which is connected to the first force sensor, and a flexible cable which is connected to the second force sensor.

The invention also relates to a method for controlling tensile forces of elongate elements, such as safety belt straps, of the type comprising a first step for adjusting a preliminary tensile force of the elongate element with this force being measured, and a second step for measuring a crash test tensile force applied to the elongate element during a crash test; according to the invention, the first and second steps are carried out by arranging, on the elongate element, a force control device in accordance with one of the above paragraphs and the method comprises, between the first and the second step, an additional step for converting the force control device by removing the additional supporting member which is provided with the preliminary tensile force sensor and for replacing it with a separable supporting member which is interchangeable therewith.

Other features and advantages of the invention will be better understood from a reading of the following description, given with reference to the appended drawing, in which:

FIG. 1, which has been described above, is a schematic, lateral view of a force control device;

FIG. 2 is a plan view of the force control device of FIG. 1; and

FIG. 3 is a lateral, sectioned view of a force control device variant which can be produced according to the invention.

The invention can be used with the force control device which is illustrated in FIGS. 1 and 2 and which is provided with an additional member.

In a first embodiment, the two bars 14 constitute separable supporting members, which are placed at a first side of the strap 16 and which are formed by solid metal rods which can be screwed into one of the end-plates of the body. The element 16 which is placed at the other side is provided with a crash test force sensor, that is to say, which can be subjected to forces which may reach 15, 20 or 25 kN or higher.

So that the force control device can be used according to the invention, it further comprises an additional bar 14 which forms a supporting member which can be interchanged with one of the bars 14, and which has outer dimensions identical to those of the bars 14 and preferably identical mechanical properties. However, this additional supporting member is provided with a force sensor which has a measurement range which covers the preliminary tensile forces, for example, of between a few Newtons and 1 kN.

In a first step, the force control device is mounted on the strap 18, and the bars which are used are, on the one hand, a normal bar 14 and, on the other hand, the additional bar which has the second force sensor. In this manner, by connecting the measurement cable of the additional bar to a measuring device, the strap can be brought to the desired preliminary tension. Once this value has been obtained, in a second step, the additional supporting member which has the second force sensor is removed and replaced with an interchangeable solid bar which has no second sensor. Given the geometric interchangeability of the two elements, the strap is subjected to the same preliminary tension. The crash test can then be carried out, and the values are measured with the sensor of the opposing supporting member 16.

FIG. 3 illustrates a force control device variant in which two bars 22 are placed at a first side of the strap 18 and a crash test force sensor 24 is placed in a supporting member at the other side of a body 20. The central portion of the body 20 advantageously has a shape which allows the measurements taken by the crash test force sensor 24 to be optimised. In this embodiment, one of the two bars 22 is constituted, in a first step, by a bar which is provided with a second preliminary tensile force sensor and, in a second step, by a solid bar which has no sensor.

Force control device embodiments have been described in which the first force sensor is associated with a single supporting member which is placed at a second side of the strap, whilst two separable supporting members which are not provided with a sensor or which are provided with a preliminary tensile force sensor are placed at the other side and are separable.

In a variant, it is the single supporting member 16 which is separable and, in the first step, it comprises a preliminary tensile force sensor and, in the second step, it comprises a crash test force sensor.

In another variant, in the first step, it is one of the bars 22 which comprises the second preliminary tensile force sensor and, in the second step, it is replaced with another bar which is provided with the first crash test force sensor.

In another variant, the first force sensor can be fixedly joined to one of the two bars which are not separable, and the second force sensor is fixedly joined to the single supporting member which is separable.

The invention also relates to a force control method for crash tests in which the same force control device according to the invention is used in a first step with a separable supporting member provided with a second preliminary tensile force sensor and, in a second step, in which crash test forces are measured, with a first force sensor which is fixedly joined to a member which may or may not be separable.

Although the invention has been described with reference to a safety belt strap, it may be used for other elongate elements which have, for example, a cross-section which is circular, oval, or another shape. It is preferable for the supporting members to have a shape which is suitable for the cross-section of the elongate element used.

Of course, various modifications may be carried out by the person skilled in the art on the control devices and methods which have been described above purely by way of non-limiting example, without departing from the scope of the invention.

1. Tensile force control device for elongate elements subjected to crash tests, of the type comprising:
a body which delimits a non-rectilinear path for an elongate element (18) to pass between at least two supporting members (14; 22) which are placed at a first side and at least one supporting member (16) which is placed at the second side,
at least one of the supporting members (14, 16; 22) being provided with a force sensor which has a measurement range which covers the forces experienced during a crash test,
each supporting member (14; 22) at least at one side of the path being able to be separated from the body, so that the tensile force control device can be placed on an elongate element (l.8) by separating each separable supporting member (14; 22) from the body, then by fixing each separable supporting member (14; 22) to the body, characterised in that it further comprises an additional supporting member which is geometrically interchangeable with a separable supporting member (14; 22), the additional supporting member being provided with a second force sensor which has a measurement range which covers the preliminary tensile forces of the elongate element, the force control device having two different configurations depending on whether a supporting member which is separable from the body comprises the second force sensor or not.

2. Control device according to claim 1, characterised in that it comprises two supporting members which are formed by two
bars (14; 22) which are placed at a first side and a single supporting member which is placed at the second side.

3. Control device according to claim 2, characterised in that the two supporting members (14; 22) are separable, and the additional supporting member (16) is intended to replace one of the two separable supporting members.

4. Control device according to claim 3, characterised in that the single supporting member (16) at the second side comprises the first force sensor.

5. Control device according to claim 3, characterised in that one of the two separable members comprises the first force sensor.

6. Control device according to claim 2, characterised in that the additional supporting member is similar to the single supporting member at the second side and can be interchanged therewith.

7. Control device according to claim 6, characterised in that the single supporting member at the second side comprises the first force sensor.

8. Control device according to claim 1, characterised in that the body comprises two lateral end-plates (12) which are intended to support the ends of the bars of the supporting members.

9. Control device according to claim 1, characterised in that the additional supporting member comprises at least one dynamometric gauge.

10. Method for controlling tensile forces of elongate elements, of the type comprising:
a first step for adjusting a preliminary tensile force of an elongate element with this force being measured, and a second step for measuring a crash test tensile force applied to the elongate element during a crash test, characterised in that the first and second steps are carried out by arranging, on the elongate element, a force control device according to claim 1, and the method comprises, between the first and the second step, an additional step for converting the force control device by removing the additional supporting member which is provided with the preliminary tensile force sensor and for replacing it with a separable supporting member which is interchangeable therewith.

11. Control device according to claim 2, characterised in that the body comprises two lateral end-plates (12) which are intended to support the ends of the bars of the supporting members.

12. Control device according to claim 3, characterised in that the body comprises two lateral end-plates (12) which are intended to support the ends of the bars of the supporting members.

13. Control device according to claim 4, characterised in that the body comprises two lateral end-plates (12) which are intended to support the ends of the bars of the supporting members.

14. Control device according to claim 5, characterised in that the body comprises two lateral end-plates (12) which are intended to support the ends of the bars of the supporting members.

15. Control device according to claim 6, characterised in that the body comprises two lateral end-plates (12) which are intended to support the ends of the bars of the supporting members.

16. Control device according to claim 7, characterised in that the body comprises two lateral end-plates (12) which are intended to support the ends of the bars of the supporting members.

17. Control device according to claim 2, characterised in that the additional supporting member comprises at least one dynamometric gauge.

18. Control device according to claim 3, characterised in that the additional supporting member comprises at least one dynamometric gauge.

19. Control device according to claim 4, characterised in that the additional supporting member comprises at least one dynamometric gauge.

20. Control device according to claim 5, characterised in that the additional supporting member comprises at least one dynamometric gauge.
